(19) United States
(12) Patent Application Publication
(10) Pub. No.: US 2001/0034861 A1
(43) Pub. Date: Oct. 25, 2001

(54) Apparatus for processing output data of base station modem for use in IS-2000 mobile communication system

(75) Inventor: Hong-Koo Kang, Ichon-shi (KR)

Correspondence Address: BAKER & BOTTS, 30 ROCKEFELLER PLAZA, NEW YORK, NY, 10112

(73) Assignee: HYUNDAI ELECTRONICS INDUSTRIES CO., LTD.

(21) Appl. No.: 09/821,351

(22) Filed: Mar. 29, 2001

(30) Foreign Application Priority Data
Apr. 25, 2000 (KR) 2000-21926

(51) Int. Cl. G06F 11/08

(52) U.S. Cl. 714/52

(57) ABSTRACT

An apparatus is disclosed converting serial data outputted from a base station modem in mobile communication systems into parallel data, and detecting a parity code for the converted data to thereby prevent an erroneous data from being transmitted to enhance a quality of call, which comprises a data conversion block for converting serial data fed thereto from a base station modem into parallel data to provide converted parallel data; a parity detection block for detecting a parity code embedded in the converted parallel data from the serial to parallel data conversion block; a status processing block for generating an interrupt according to a status of the detected parity code and maintaining the status until a clear signal is received; and an output control block for monitoring the detected parity status inputted thereto from the parity detection block, outputting a logic low signal if an error is occurred, and outputting the parallel data fed thereto from the data conversion block if otherwise.

### FIELD OF THE INVENTION

The present invention relates to an apparatus for processing output data of a base station modem for use in IS-2000; and, more particularly, to an apparatus for converting serial data outputted from a base station modem in IS-2000 mobile communication system into parallel data, and detecting a parity code from the converted data to thereby prevent an erroneous data from being transmitted.

### DESCRIPTION OF THE PRIOR ART

FIGS. 1A and 1B are block diagrams of an output data processing apparatus used in a conventional CDMA base station modem, respectively. In FIG. 1A, a multiplicity of base station modulators (BSMs) 1 to 4 of first-generation chip requires three digital combiners 5-1, 5-2 and 5-3 each of which respectively corresponding to α, β and γ, to process data to be transmitted. In FIG. 1b, the use of a cell site modem (CSM) 6 of second-generation chip requires a multiplicity of output data processing apparatuses 7-1 to 7-6 to process data to be transmitted.

As mentioned above, the conventional output data processing apparatus converts serial data outputted from the CDMA base station modem into parallel data and monitors a status of the converted data.

Since, however, the conventional output data processing apparatus supporting only three sectors processes only data outputted from the base station modem, through four lines per one sector, it is difficult to process data to be outputted from a base station modem for use in IS-2000 mobile communication system.

Accordingly, it would be desirable to develop a processing device which is capable of performing a serial to parallel converting and monitoring functions adapted for the IS-2000 base station modem.

### SUMMARY OF THE INVENTION

It is, therefore, an object of the present invention to provide an apparatus, which is capable of converting serial data outputted from a base station modem in mobile communication systems into parallel data, and detecting a parity code for the converted data to thereby prevent an erroneous data from being transmitted to enhance a quality of call.

In accordance with a preferred embodiment of the present invention, there is provided an apparatus for processing output data of a base station modem for use in an IS-2000 mobile communication system, which comprises; a data conversion means for converting serial data fed thereto from a base station modem into parallel data to provide converted parallel data; a parity detection means for detecting a parity code embedded in the converted parallel data from the data conversion means; a status processing means for generating an interrupt according to a status of the detected parity code by the parity detection means, and maintaining the status until a clear signal is received; and an output control means for monitoring the detected parity status inputted thereto from the parity detection means, outputting a logic low signal if an error is occurred, and outputting the parallel data fed thereto from the data conversion means if otherwise.

### BRIEF DESCRIPTION OF THE DRAWINGS

The above and other objects and features of the present invention will become apparent from the following description of the preferred embodiments given in conjunction with the accompanying drawings, in which:

FIGS. 1A and 1B are block diagrams of an output data processing apparatus used in a conventional CDMA base station modem, respectively;

FIG. 2 is a block diagram of an output data processing apparatus of a base station modem for use in IS-2000 communication systems in accordance with a preferred embodiment of the present invention;

FIG. 3 is a detailed block diagram of one of the output data processing apparatuses shown in FIG. 2;

FIG. 4 is a detailed block diagram of the data conversion block shown in FIG. 3;

FIG. 5 is a further detailed block diagram of the data conversion block shown in FIG. 4;

FIG. 6 illustrates, in timing diagram form, data generated from each block in the data conversion block shown in FIG. 5;

FIG. 7 is a detailed block diagram of the status-processing block shown in FIG. 3; and

FIG. 8 is a detailed block diagram of the output control block shown in FIG. 3.

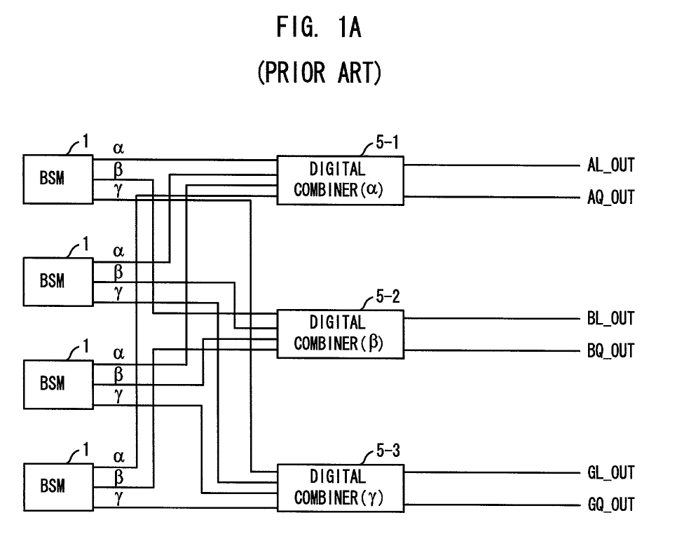

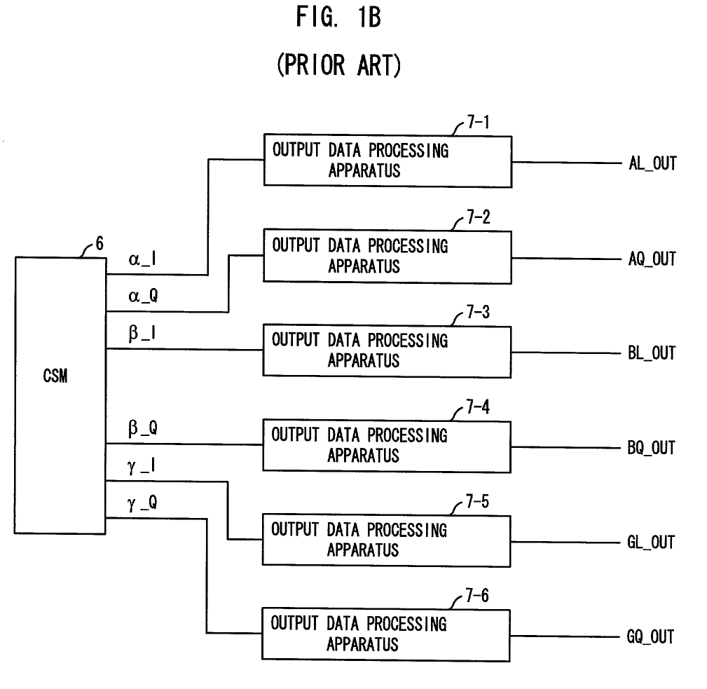

### DETAILED DESCRIPTION OF THE PREFERRED EMBODIMENTS

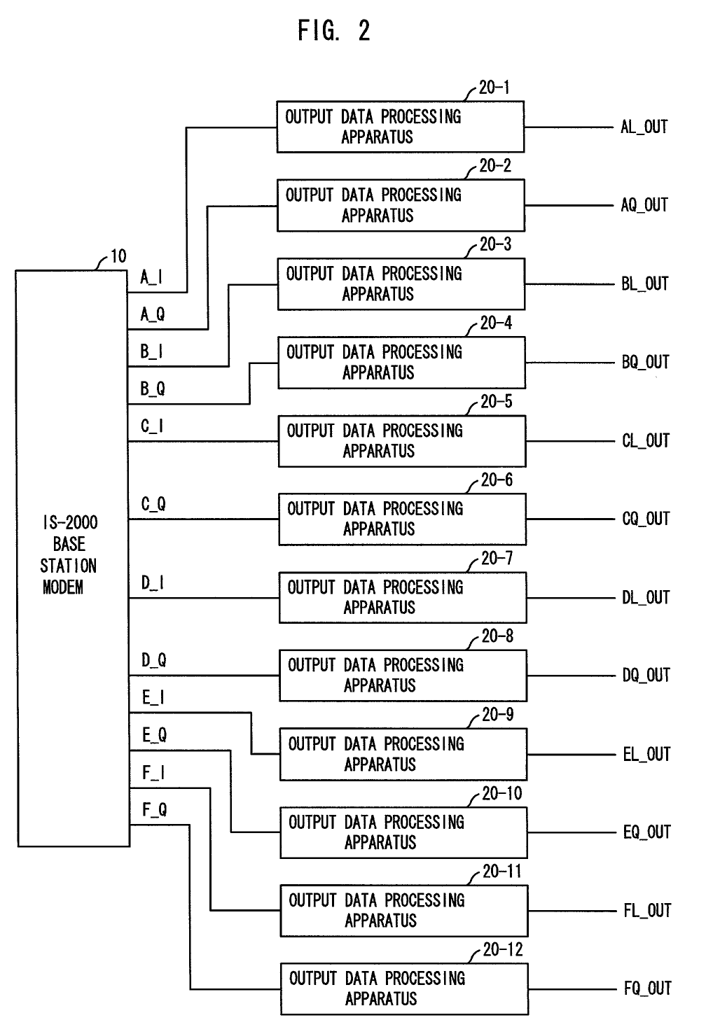

FIG. 2 is a block diagram of an output data processing apparatus of a base station modem for use in IS-2000 communication systems in accordance with a preferred embodiment of the present invention. In FIG. 2, each of twelve output data processing apparatuses 20-1 to 20-12 receives each of twelve serial data A_I, A_Q, B_I, B_Q, C_I, C_Q, D_I, D_Q, E_I, E_Q, F_I and F_Q outputted from a base station modem 10, converts each received data into parallel data and monitors a status of each data.

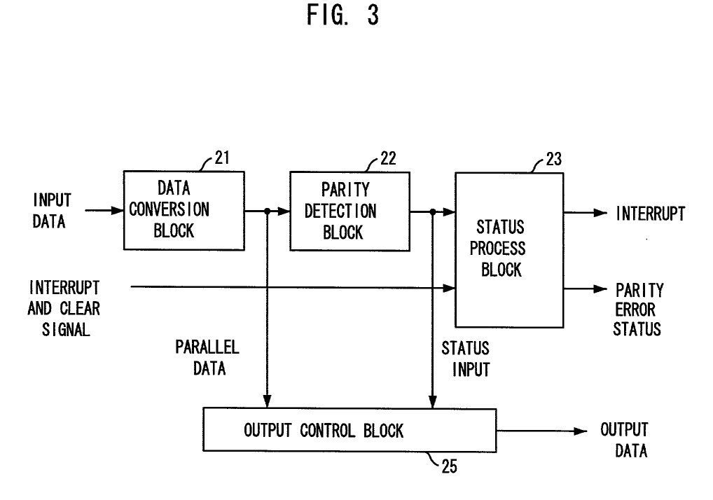

FIG. 3 is a detailed block diagram of one of the output data processing apparatuses shown in FIG. 2, which includes a data conversion block 21 for converting serial data fed thereto from the base station modem 10 into parallel data, a parity detection block 22 for detecting a parity code embedded in the parallel data from the data conversion block 21, a status processing block 23 for generating an interrupt according to a status of the detected parity code and maintaining the status until a clear signal is received from a CPU (not shown), and an output control block 24 for determining the detected parity status inputted thereto from the parity detection block 22, outputting a logic low signal if an error is occurred, and outputting the parallel data fed thereto from the data conversion block 21 if otherwise.

Wherein, the data outputted through each channel in the base station modem 10 includes one parity bit and fifteen data bits of two's complement.

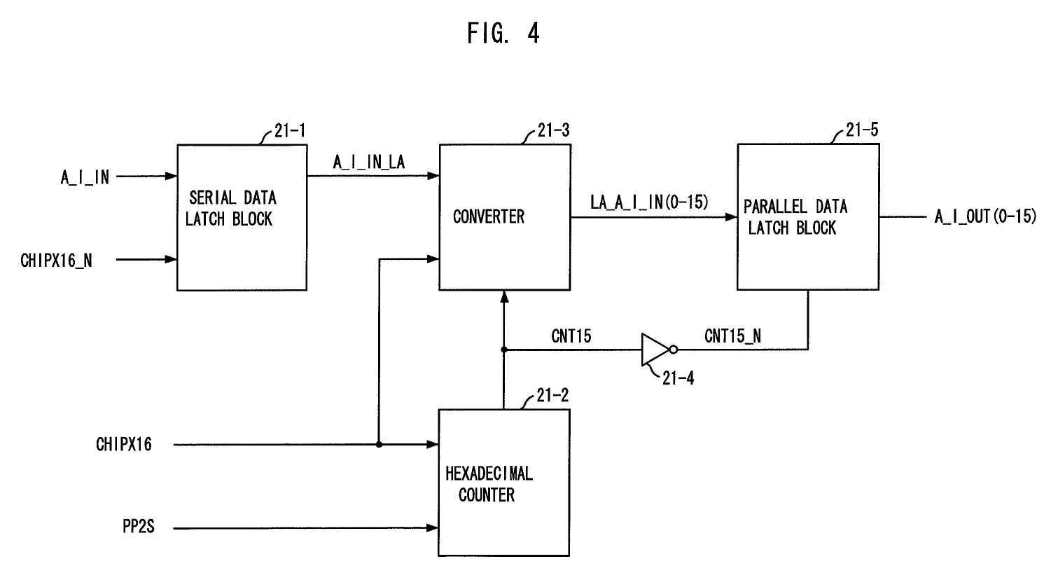

FIG. 4 is a detailed block diagram of the data conversion block 21 shown in FIG. 3. The data conversion block 21 includes a serial data latch block 21-1 for latching the serial data fed thereto from the base station modem 10; a hexadecimal counter 21-2 for sequentially outputting sixteen counted values; a converter 21-3 for converting the serial data fed thereto from the serial data latch block 21-1 into the parallel data according to the counted value fed thereto from the hexadecimal counter 21-2; an inverter 21-4 for inverting a 15th counted value CNT15 fed thereto from the hexadecimal counter 21-2 to output an inverted value CNT_N; and parallel data latch block 21-5 for latching each of the converted parallel data LA_A_I_IN0 to LA_A_I_IN15 fed thereto from the converter 21-3 and outputting each of the parallel data A_L_OUT0 to A_L_OUT15 at a same timing according to the inverted value from the inverter 21-4.

That is, since timings of each parallel data to be outputted from the converter 21-3 are different from each other, the parallel data latch block 21-5 first latches each of the parallel data and outputs each of the parallel data at a same timing according to the inverted value (i.e., counted value) of the inverter 21-4.

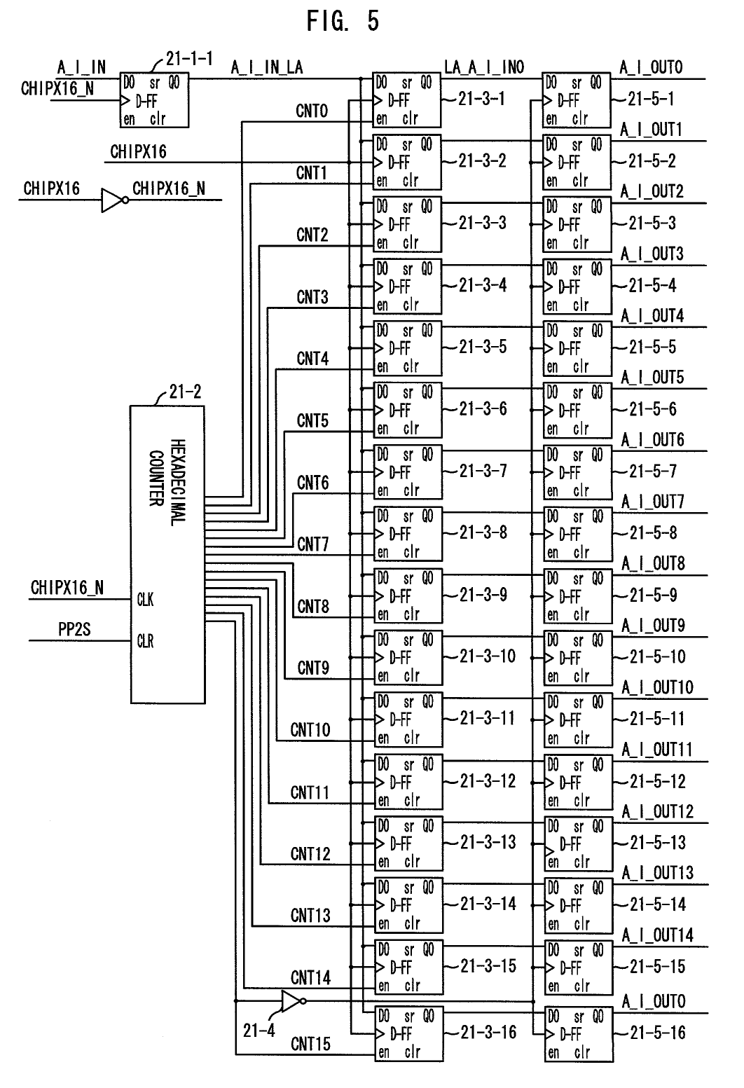

FIG. 5 is a further detailed block diagram of the data conversion block 21 shown in FIG. 4. The serial data latch block 21-1 includes a D-flip flop 21-1-1 for latching the serial data A_I_IN fed thereto from the base station modem 10. The converter 21-3 includes D-flip flops 21-3-1 to 21-3-16 for latching each of the serial data A_I_IN from the D-flip flop 21-1-1 and then sequentially outputting the latched data LA_A_IN0 to LA_A_IN15 according to the counted value from the hexadecimal counter 21-2 to thereby convert the serial data into the parallel data. The parallel data latch block 21-5 includes D-flip flops 21-5-1 to 21-5-16 for latching each of the parallel data fed thereto from the D-flip flops 21-3-1 to 21-3-16 and outputting each of the latched parallel data A_I_OUT0 to A_I_OUT15 at a same timing based on the counted value from the inverter 21-4.

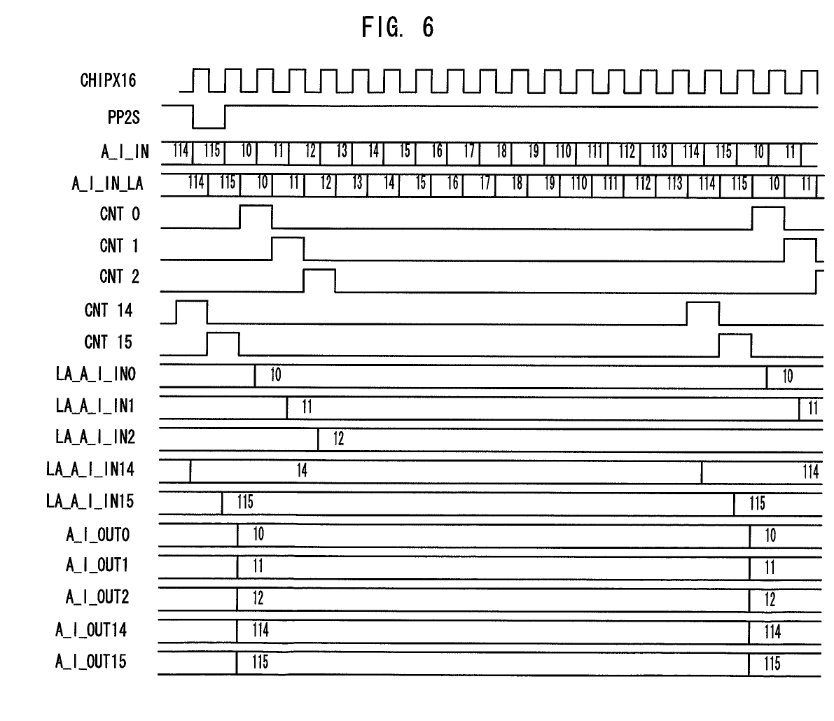

FIG. 6 illustrates, in timing diagram form, data generated from each block in the data conversion block 21 shown in FIG. 5.

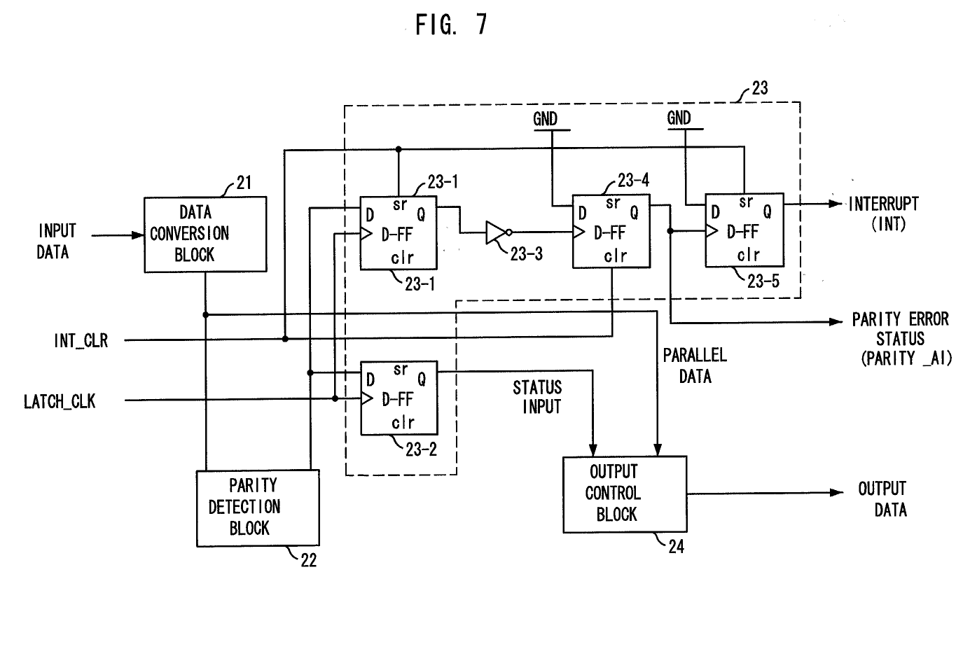

FIG. 7 is a detailed block diagram of the status processing block 23 shown in FIG. 3, which includes a D-flip flop 23-1 for latching the parity status data detected by the parity detection block 22, a D-flip flop 23-2 for latching the parity status data and outputting the same to the output control block 24, an inverter 23-3 for inverting the parity status data fed thereto from the D-flip flop 23-1, a D-flip flop 23-4 for receiving the inverted parity status data from the inverter 23-3 as a clock signal and outputting information of a parity error status, and a D-flip flop 23-5 for receiving the status information from the D-flip flop 23-4 as a clock signal to output an interrupt INT.

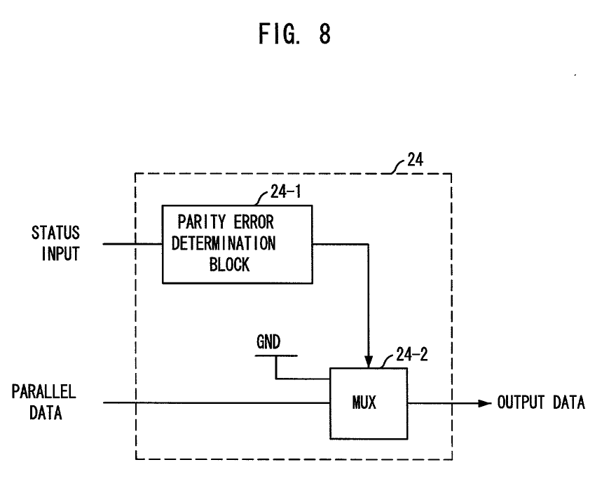

FIG. 8 is a detailed block diagram of the output control block 24 shown in FIG. 3, which includes a parity error determination block 24-1 for monitoring a status of the D-flip flop 23-2 in the status processing block 23 and determining whether or not an error is occurred, and a multiplexer (MUX) 24-2 for selectively outputting GND input or the parallel data according to the determined results in the parity error determination block 24-1. That is, the multiplexer 24-2 outputs the GND input if the error is occurred, and outputs the converted parallel data fed thereto from the converter 21 if otherwise.

A detailed explanation of operation of the inventive output data processing apparatus will now be provided hereinafter.

First, the data conversion block 21 in the output data processing apparatus 20-1 to 20-12 converts the serial data fed thereto from the base station modem 10 into the parallel data.

Specifically, the D-flip flop 21-1-1 in the serial data latch block 21-1, in response to CHIPX16_N fed thereto, serves to latch the serial data A_I_IN fed thereto from the base station modem 10 and outputs the same to each of the D-flip flops 23-3-1 to 23-3-16 in the converter 21-3 shown in FIG. 5.

The reason why the serial data latch block 21-1 latches the serial data is to prevent that a delayed timing of the data outputted from the base station modem 10 may cause a problem during the serial to parallel conversion.

Each of the D-flip flops 21-3-1 to 21-3-16 in the converter 21-3 serves to latch the serial data A_I_IN_LA fed thereto from the D-flip flop 21-1-1 and then sequentially outputs the latched data LA_A_I_IN0 to LA_A_I_IN15 to the parallel data latch block 21-5 based on 16 counted values CNT0 to CNT15 from the hexadecimal counter 21-2.

Specifically, each of the D-flip flops 21-3-1 to 21-3-16 outputs the serial data A_I_IN_LA as a sequence of latched data LA_A_I_IN0 to LA_A_I_IN15 if the clock signal is inputted thereto during a high level of enable signal EN, and holds an inactive state if the clock signal is inputted thereto during a low level of enable signal EN.

At the first clock, if the pp2s signal is pulled to a logic high level and the first counted value CNT0 is pulled to a logic high, then the 1st D-flip flop 23-3-1 is enabled to latch a first data A_I_IN_LA0. Next, at a subsequent clock, the first counted value CNT0 is pulled down a logic low and a second counted value CNT1 is pulled to a logic high, then the 2nd D-flip flop 23-3-2 is enabled to latch a second data A_I_IN LA1, and so on.

Finally, at the 15th clock, if the 15th counted value CNT15 is pulled to a logic high pulse, the 15th D-flip flop 23-3-16 is enabled to latch 15th data A_I_IN_LA15.

As shown in FIG. 6, since each of the data LA_A_I_IN0 to LA_A_I_IN15 outputted from the D-flip flops 23-3-1 to 23-3-16 in the converter 21-3 is different from each other in a starting timing, these data are transmitted to the parallel data latch block 21-5 to synchronize the timing for each data.

In this case, the hexadecimal counter 21-2 is cleared if the pp2s signal is pulled down a logic low level and begins to count if the pp2s signal is pulled to a logic high level. Wherein the counting process is performed in synchronism with a falling edge of the data CHIPX16.

Thereafter, if the 15th counted value CNT15 from the hexadecimal counter 21-2 is inverted by the inverter 21-4 and the inverted result CNT15_N is forwarded to a clock port CLK in each of the D-flip flops 21-5-1 to 21-5-16 in the parallel data latch block 21-5. In response to a clock of the counted value CNT15, each of the D-flip flops 21-5-1 to 21-5-16 latches the data LA_A_I_IN0 to LA_A_I_IN15 fed thereto from the D-flip flops 23-3-1 to 23-3-16, and outputs a sequence of the parallel data A_I_OUT0 to A_I_OUT15 at the same timing based on the counted value from the inverter 21-4.

In this case, since timings of each parallel data to be outputted from the converter 21-3 are different from each other, the parallel data latch block 21-5 first latches each of the parallel data and outputs each of the parallel data at a same timing according to the inverted value (i.e., counted value) of the inverter 21-4.

Each timing charts associated with the signal CHIPX16, the PP2S signal, the serial data A_I_IN, the latched serial data A_I_IN_LA, the counted signals CNT0 to CNT15, the latched data LA_A_I_IN0 to LA_A_I_IN15, and the parallel data A I_OUT0 to A_I_OUT15 are presented in FIG. 6.

Meanwhile, the parity detection block 22 in FIG. 3 detects an odd parity code in the parallel data fed thereto from the data conversion block 21 to determine if the parallel data contains an error therein, and outputs the resultant data to the status processing block 23 and the output control block 24, respectively.

The status-processing block 23 generates an interrupt according to the detected parity status provided from the parity detection block 22 and holds the status until a clear signal is received from a CPU (not shown). The output control block 24 determines the detected parity status inputted thereto from the parity detection block 22, outputs a logic low signal if an error is occurred, and outputs the parallel data fed thereto from the data conversion block 21 if otherwise.

The status process block 23 initializes the interrupt as a high level and the parity status as a low level with a signal INT_CLR from the CPU.

In operation, the parity detection block 22 generates a logic low parity status if input data is erroneous and the status process block 23 latches the logic low parity status through the use of the D-flip flop 23-1.

The D-flip flop 23-2 provides a logic high output signal to the output control block 24, the output signal being changed in correspondence with the clock LATCH_CLK.

The inverter 23-3 performs an inversion operation on the logic low parity status data outputted from the D-flip flop 23-1 and outputs an inverted signal, i.e., a logic high signal, to a clock port CLK in the D-flip flop 23-4.

The D-flip flop 23-4 receives the logic low parity status data from the inverter 23-3 as a clock signal, outputs a logic high signal Vcc to a clock port CLK in the D-flip flop 23-5 and outputs a logic low of parity error status data PARITY_AI.

The D-flip flop 23-5 receives the high parity error status data from the D-flip flop 23-4 as a clock signal and outputs a logic low signal GND as the interrupt INT.

In case the error is generated, the interrupt is rendered from a high level to a low level and the parity error status is rendered from a low level to a high level.

If no error is generated, the output of the parity detection block 22 is rendered to a logic high signal and the clock of the D-flip flop 23-4 is rendered from a high level to a low level. In this case, since the D-flip flop 23-4 is operated at a positive edge, it holds the interrupt and the parity error status without outputting.

The CPU reads the parity error status in response to the interrupt to output the signal INT_CLR to thereby initialize the interrupt and the parity status.

In the output control block 24, the parity error determination block 24-1 monitors the status of the D-flip flop 23-2 in the status process block 23 to determine whether or not a parity error is occurred.

The multiplexer 24-2 outputs the GND input if the parity error is occurred, and outputs the converted parallel data fed thereto from the converter 21 if otherwise.

In accordance with the present invention, there is provided an effect of enhancing a quality of a call by converting serial data outputted from a base station modem for IS-2000 mobile communication systems into parallel data to output the same toward an IF terminal and by preventing erroneous data from being transmitted to a terminal by detection of a parity status for the converted data.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for processing output data of a base station modem for use in an IS-2000 mobile communication system, which comprises;
a data conversion means for converting serial data fed thereto from a base station modem into parallel data to provide converted parallel data;
a parity detection means for detecting a parity code embedded in the converted parallel data from the data conversion means;
a status processing means for generating an interrupt according to a status of the detected parity code by the parity detection means, and maintaining the status until a clear signal is received; and
an output control means for monitoring the detected parity status inputted thereto from the parity detection means, outputting a logic low signal if an error is occurred, and outputting the parallel data fed thereto from the data conversion means if otherwise.

2. The apparatus of claim 1, wherein the data conversion means includes:
a serial data latching means for latching the serial data fed thereto from the base station modem;
a counting means for sequentially outputting sixteen counted values;
means for converting the serial data fed thereto from the data latching means into the parallel data according to the counted value fed thereto from the counting means;
means for inverting a final counted value fed thereto from the counting means to output an inverted value; and
a parallel data latching means for latching each of the converted parallel data fed thereto from the converting means and outputting each of the parallel data at a same timing according to the inverted value from the inverting means.

3. The apparatus of claim 1, wherein the status processing means includes:
a first latching means for latching the parity status data detected by the parity detection means;
a second latching means for latching the parity status data to provide the same to the output control means;
an inverting means for inverting the parity status data fed thereto from the first latching means;
a third latching means for receiving the inverted parity status data from the inverting means as a clock signal and outputting information of a parity error status; and
a fourth latching means for receiving the status information from the third latching means as a clock signal to output an interrupt.

4. The apparatus of claim 1, wherein the output control means includes:
a parity error determination means for monitoring a status of the second latching means in the status processing means to determine whether or not an error is occurred; and
means, responsive to the determination results from the parity error determination means, for selectively outputting a ground input if the error is occurred, and outputting the converted parallel data fed thereto from the converting means if otherwise, wherein the outputting means has the ground at its one input.
